(19) United States
(12) Patent Application Publication
(10) Pub. No.: US 2026/0233210 A1
(43) Pub. Date: Aug. 13, 2026

(54) HYDROTHERMAL TREATMENT METHOD OF MWW TYPE ZEOLITE SUPPORTS AND MANUFACTURING METHOD OF MO-BASED METHANE DEHYDROAROMATIZATION CATALYSTS USING MWW TYPE ZEOLITE SUPPORTS DEALUMINATED BY HYDROTHERMAL TREATMENT

(71) Applicant: Korea University Research and Business Foundation, Seoul (KR)

(72) Inventors: Jungkyu CHOI, Seoul (KR); TRISTAN JAMES SIM, Seoul (KR); Yun Ha SONG, Seoul (KR)

(21) Appl. No.: 19/410,110

(22) Filed: Dec. 5, 2025

(30) Foreign Application Priority Data
Feb. 7, 2025 (KR) 10-2025-0015556

(51) Int. Cl. B01J 29/78; B01J 29/70; B01J 37/02; B01J 37/08; B01J 37/10; B01J 37/30; C01B 39/02

(52) U.S. Cl. CPC B01J 29/7876; B01J 29/7038; B01J 37/0207; B01J 37/088; B01J 37/10; B01J 37/30; C01B 39/026; B01J 2229/16; B01J 2229/36; B01J 2229/40; C01P 2002/82

(57) ABSTRACT

The present invention relates to a hydrothermal treatment method for MWW type zeolite supports and a method for preparing a Mo based methane dehydroaromatization catalyst using an MWW type zeolite support that has been dealuminated through the hydrothermal treatment. The method includes synthesizing a proton type zeolite support and hydrothermally treating the synthesized proton type zeolite support at 300 to 450° C. under an airflow containing a predetermined amount of steam to obtain a dealuminated zeolite support. Through the hydrothermal treatment, an MWW type zeolite support can be modified and dealuminated. According to the present invention, dealumination of the zeolite enables control of Brønsted acid sites and reduction of hard coke formation, thereby improving BTX (benzene, toluene, xylenes) selectivity in the methane dehydroaromatization reaction. The invention further enables improvement of the performance of the Mo based methane dehydroaromatization catalyst prepared using the dealuminated support.

### CROSS-REFERENCE TO RELATED APPLICATIONS

This application claims priority to and the benefit of Korean Patent Application No. 10-2025-0015556 filed in the Korean Intellectual Property Office on Feb. 7, 2025, the entire contents of which are incorporated herein by reference.

### TECHNICAL FIELD

The present invention relates to a hydrothermal treatment method for MWW-type zeolite supports for dealumination, and to a method for preparing Mo-based methane dehydroaromatization catalysts using MWW-type zeolite supports dealuminated by the hydrothermal treatment.

### BACKGROUND ART

Methane, the major component of natural gas, is widely recognized as a key strategic resource for producing high-value-added chemicals as part of future sustainable energy and chemical feedstock systems. In recent years, extensive research has been conducted on the conversion of methane into value-added products such as hydrogen, olefins, oxygenates, and aromatic compounds. Conventional indirect conversion processes consume substantial energy due to their endothermic nature and inevitably generate CO2. Consequently, environmentally friendly direct methane conversion processes applicable even on a small scale have been actively investigated.

Methane dehydroaromatization (MDA) is a process aimed at converting methane into aromatic compounds, such as benzene, toluene, and xylenes (collectively referred to as “BTX”), driven by the increasing demand for aromatics. Zeolite supports that provide Brønsted acid sites are commonly used, and catalyst performance can be improved by loading molybdenum (Mo) onto the zeolite. Among zeolites, the MWW-type zeolite MCM-22, which contains 10-membered-ring (10-MR) and 12-membered-ring (12-MR) pore structures, is widely employed. In Mo-loaded MCM-22, Mo species act as dehydrogenation sites producing C2 intermediates from methane, while the Brønsted acid sites in MCM-22 promote aromatic formation within the zeolite pores.

However, Brønsted acid sites may also induce coke formation, which lowers BTX selectivity. Therefore, catalysts with optimized acidity must be developed to improve MDA reaction performance.

Dealumination of zeolites-selective removal of aluminum atoms from the framework-serves as an effective method to tune acidity. Dealumination can be achieved through hydrothermal treatment, acid treatment, and the like, and is widely used in industrial catalytic processing.

### PRIOR ART DOCUMENT

Patent Documents: KR 10-2295224 B1 (2021.08.24)

### SUMMARY OF THE INVENTION

According to an aspect of the present invention, there is provided a hydrothermal treatment method for MWW-type zeolite supports for dealumination, and a method for preparing Mo-based methane dehydroaromatization (MDA) catalysts using MWW-type zeolite supports dealuminated through the hydrothermal treatment.

According to another aspect of the invention, dealumination of zeolites allows control of Brønsted acid sites and reduction of hard coke formation, thereby improving BTX (benzene, toluene, xylenes) selectivity in the MDA reaction. Thus, the invention aims to provide a hydrothermal treatment method for MWW-type zeolite supports and a method for preparing Mo-based MDA catalysts using the dealuminated MWW-type zeolite supports.

According to yet another aspect of the invention, the hydrothermal treatment method and catalyst preparation method can enhance the performance of Mo-based MDA catalysts and increase the yield of aromatic compounds.

The problems addressed by the present invention are not limited to those mentioned above. Other problems not explicitly stated will be clearly understood by those skilled in the art from the following description.

According to an aspect of the present invention, the hydrothermal treatment method for MWW-type zeolite supports comprises: synthesizing a proton-type zeolite support; and hydrothermally treating the synthesized proton-type zeolite support at 300° C. to 450° C. under an airflow containing a predetermined amount of steam to obtain a dealuminated zeolite support.

In one embodiment, synthesizing the proton-type zeolite support may comprise synthesizing the zeolite support with a Si/Al ratio of 5 to 60.

In another embodiment, obtaining the dealuminated zeolite support may comprise hydrothermal treatment under an airflow of 50 to 5000 mL·min-1 containing 1 to 80 mol % steam.

In another embodiment, the hydrothermal treatment may be carried out while injecting deionized water at a constant flow rate of 1 to 100 mL·h⁻¹.

In one embodiment, synthesizing the proton-type zeolite support may comprise: preparing an MCM-22 zeolite precursor; stirring the MCM-22 precursor at 100 to 500 rpm; heat-treating the resulting precursor at 120 to 150° C. and 10 to 100 rpm for 6 to 12 days to obtain a solid product; calcining the solid product under an airflow at 400 to 650° C. for 3 to 48 hours to obtain calcined MCM-22; ion-exchanging the calcined MCM-22; and calcining the ion-exchanged MCM-22 under an airflow at 400 to 650° C. for 3 to 48 hours to obtain a proton-type MCM-22 zeolite support.

In another embodiment, preparing the MCM-22 zeolite precursor may comprise: dissolving hexamethyleneimine (HMI), sodium aluminate, and sodium hydroxide in deionized water to prepare a precursor solution; and adding fumed silica to the precursor solution to obtain an MCM-22 precursor having a Si/Al ratio of 5 to 60.

The sodium aluminate may have a composition of 55 wt % Al₂O₃ and 45 wt % Na₂O.

In another embodiment, calcining the MCM-22 to obtain the calcined product may comprise heating at 400 to 650° C. for 3 to 48 hours under an airflow of 50 to 5000 mL·min⁻¹ at a ramping rate of 1 to 5° C.·min⁻¹.

In another embodiment, the ion-exchange step may comprise mixing the calcined MCM-22 with an aqueous NH₄NO₃ solution at room temperature for 12 to 24 hours to exchange Na⁺ ions present in the calcined MCM-22. The ion-exchange may be performed once or multiple times.

In another embodiment, obtaining the proton-type MCM-22 zeolite support may comprise calcining under an airflow of 50 to 5000 mL·min⁻¹ at 400 to 650° C. for 12 to 24 hours at a ramping rate of 1 to 5° C.·min⁻¹.

According to another aspect of the invention, the method for preparing an Mo-based methane dehydroaromatization catalyst using a hydrothermally dealuminated MWW-type zeolite support comprises: impregnating the hydrothermally treated proton-type MCM-22 zeolite support with Mo through an impregnation method; drying the Mo-impregnated proton-type MCM-22 zeolite support at 60 to 80° C. for 12 to 24 hours; and calcining the dried material at 500 to 600° C. under an airflow for 3 to 48 hours to synthesize the Mo-based MDA catalyst.

In one embodiment, the impregnating step may comprise impregnating with an aqueous ammonium heptamolybdate tetrahydrate solution [(NH₄)₆Mo₇O₂₄·4H₂O] to load Mo onto the hydrothermally treated proton-type MCM-22.

In another embodiment, the Mo loading amount may be 1 to 10 wt %.

In another embodiment, calcination for synthesizing the Mo-based MDA catalyst may be performed under an airflow of 250 to 350 mL·min⁻¹ at 500 to 600° C. at a ramping rate of 1 to 5° C.·min⁻¹.

In another embodiment, the hydrothermally treated proton-type MCM-22 zeolite support may be one obtained by the hydrothermal treatment method described in any of claims 1 through 9.

According to the present invention, the MWW-type zeolite support (proton-type MCM-22) can be modified and dealuminated through hydrothermal treatment.

Further, dealumination allows control of Brønsted acidity and reduction of hard coke formation, thereby improving BTX selectivity in the MDA reaction.

Moreover, the performance of Mo-based methane dehydroaromatization catalysts and the yield of aromatic compounds can be significantly enhanced.

### BRIEF DESCRIPTION OF THE DRAWINGS

FIG. 1 is a diagram illustrating a hydrothermal treatment method for MWW type zeolite supports according to an embodiment of the present invention.

FIG. 2 is a diagram illustrating a step of synthesizing a proton type zeolite support in the hydrothermal treatment method for MWW type zeolite supports according to an embodiment of the present invention.

FIG. 3 is a diagram illustrating a step of preparing a zeolite precursor in the hydrothermal treatment method for MWW type zeolite supports according to an embodiment of the present invention.

FIG. 4 is a diagram illustrating a method for preparing a Mo based methane dehydroaromatization catalyst using a hydrothermally dealuminated MWW type zeolite support according to an embodiment of the present invention.

FIG. 5 shows data obtained from Py adsorption FT IR and NH3 TPD measurements for confirming acid site changes of Mo based methane dehydroaromatization catalysts according to an embodiment of the present invention.

FIG. 6 shows data obtained from the methane dehydroaromatization reaction of Mo based catalysts according to an embodiment of the present invention.

FIG. 7 shows measurement data including the MDA reaction results of catalysts hydrothermally treated at 200 to 600° C. according to an embodiment of the present invention.

FIG. 8 shows data obtained from coke analysis of the Mo based methane dehydroaromatization catalysts according to an embodiment of the present invention.

### DETAILED DESCRIPTION

The preferred embodiments of the present invention will now be described in detail with reference to the accompanying drawings. The advantages, features, and methods of achieving the objectives of the invention will become apparent from the embodiments described below in conjunction with the drawings. However, the invention is not limited to the embodiments described, and may be implemented in various other forms. Rather, the embodiments are provided to fully convey the spirit and scope of the invention to those skilled in the art. Identical reference numerals used throughout the specification refer to identical structural elements.

The terminology used herein is for the purpose of describing embodiments and is not intended to limit the invention. Unless otherwise stated, the singular forms include plural forms as well. The terms “comprises” and “comprising” do not exclude the presence of additional elements, steps, operations, or components beyond those explicitly mentioned. In addition, the order of the embodiments or steps described does not limit the invention unless expressly required.

The invention will now be described with reference to the drawings.

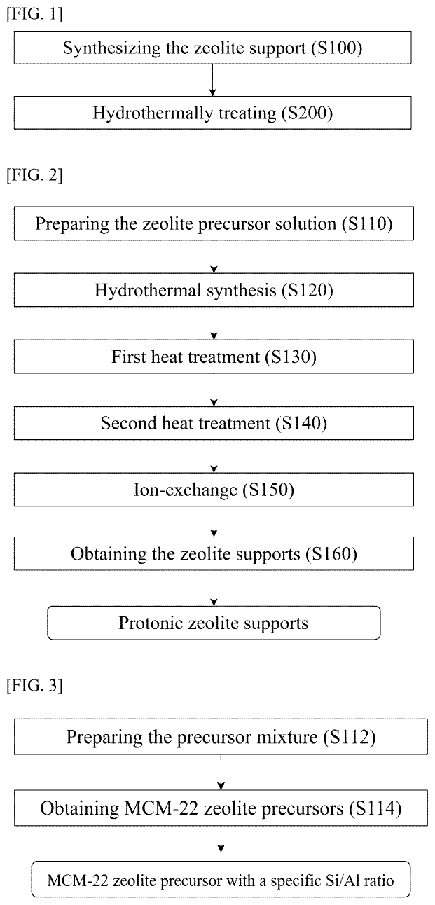

FIG. 1 is a diagram illustrating a hydrothermal treatment method for MWW type zeolite supports according to an embodiment of the present invention. FIG. 2 illustrates a step of synthesizing a proton type zeolite support in the hydrothermal treatment method. FIG. 3 illustrates a step of preparing a zeolite precursor.

Referring to FIG. 1, the hydrothermal treatment method for MWW type zeolite supports according to an embodiment of the present invention may comprise: a step S100 of synthesizing a proton type zeolite support and a step S200 of hydrothermally treating the zeolite support.

In step S100, the proton type zeolite support may be synthesized to have a Si Al ratio of 5 to 60. For example, the Si Al ratio may be 15, 30, or 50.

Referring to FIG. 2, the step S100 of synthesizing the proton type zeolite support may comprise: step S110 of preparing an MCM 22 zeolite precursor, step S120 of stirring the MCM 22 precursor at 100 to 500 rpm, step S130 of heat treating the mixture at 120 to 150° C. and 10 to 100 rpm for 6 to 12 days to obtain a solid product, step S140 of calcining the obtained solid product under an airflow at 400 to 650° C. for 3 to 48 hours to obtain calcined MCM 22, step S150 of ion exchanging the calcined MCM 22 and step S160 of calcining the ion exchanged MCM 22 under an airflow at 400 to 650° C. for 3 to 48 hours to obtain a proton type MCM 22 zeolite support.

Referring to FIG. 3, the precursor preparation step S110 may comprise: step S112 of preparing a precursor solution by dissolving hexamethyleneimine HMI, sodium aluminate, and sodium hydroxide in deionized water and step S114 of adding fumed silica to the precursor solution to obtain an MCM 22 precursor with a Si Al ratio of 5 to 60. The sodium aluminate may have a composition of 55 weight percent Al₂O₃ and 45 weight percent Na₂O.

The step S114 of obtaining the MCM-22 zeolite precursor may include adding fumed silica to the precursor solution prepared in the precursor-solution preparation step (S112), thereby obtaining an MCM-22 zeolite precursor having a Si/Al ratio of 5 to 60.

In step S140, the calcination may be performed at 400 to 650° C. for 3 to 48 hours under an airflow of 50 to 5000 mL per min at a ramping rate of 1 to 5° C. per min.

In step S150, the ion exchange may be carried out by adding the calcined MCM-22 into an aqueous NH₄NO₃ solution and stirring at room temperature for 12 to 24 hours to exchange Na⁺ ions. The ion exchange may be repeated once or multiple times.

In step S160, the proton type MCM-22 zeolite support may be obtained by calcining under an airflow of 50 to 5000 mL per min at 400 to 650° C. for 12 to 24 hours at a ramping rate of 1 to 5° C. per min.

In step S200, the synthesized proton type zeolite support may be hydrothermally treated at 300 to 450° C. under an airflow containing a predetermined amount of steam to obtain a dealuminated zeolite support.

The hydrothermal treatment step S200 may be carried out under an airflow of 50 to 5000 mL per min containing 1 to 80 mol percent steam.

In addition, deionized water may be injected at a constant flow rate of 1 to 5 mL per hour during the hydrothermal treatment.

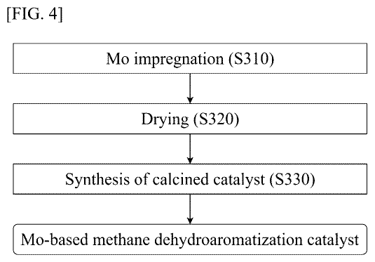

FIG. 4 is a diagram illustrating a method for preparing a Mo based methane dehydroaromatization catalyst using a hydrothermally dealuminated MWW type zeolite support according to an embodiment of the present invention.

Referring to FIG. 4, the method for preparing a Mo based methane dehydroaromatization catalyst using a hydrothermally dealuminated MWW type zeolite support may comprise: step S310 of loading Mo onto the hydrothermally treated proton type MCM 22 zeolite support through an impregnation method, step S320 of drying the Mo loaded proton type MCM 22 zeolite support at 60 to 80° C. for 12 to 24 hours and step S330 of calcining the dried Mo loaded proton type MCM 22 zeolite support at 500 to 600° C. under an airflow for 3 to 48 hours to synthesize the Mo based methane dehydroaromatization catalyst.

In step S310, Mo may be loaded onto the hydrothermally treated proton type MCM 22 zeolite support through impregnation using an aqueous ammonium heptamolybdate tetrahydrate solution (NH₄)₆Mo₇O₂₄·4H₂O.

In step S310, the Mo loading amount may be 1 to 10 weight percent. For example, Mo may be loaded at 6 weight percent onto the hydrothermally treated proton type MCM 22 zeolite support.

In step S320, the Mo loaded proton type MCM 22 zeolite support may be dried at 60 to 80° C. for 12 to 24 hours.

In step S330, the Mo loaded proton type MCM 22 zeolite support may be calcined at 500 to 600° C. under an airflow for 3 to 48 hours to synthesize the Mo based methane dehydroaromatization catalyst. The calcination may be performed at 500 to 600° C. under an airflow of 50 to 5000 mL per min at a temperature ramping rate of 1 to 5° C. per min.

The hydrothermally treated proton type MCM 22 zeolite support may be the proton type MCM 22 support obtained by the hydrothermal treatment method described in the method for hydrothermal treatment of MWW type zeolite supports described above.

### Examples

The following examples are provided for better understanding of the invention and are not intended to limit the invention in any way.

### 1. Synthesis of Zeolite Support

MCM 22 (MWW type zeolite) was obtained from an MCM 22 precursor.

Hexamethyleneimine HMI (99 percent, Sigma Aldrich), sodium aluminate (approximately 55 percent Al₂O₃ and 45 percent Na₂O, Sigma Aldrich), and sodium hydroxide (98 percent, anhydrous pellets, Sigma Aldrich) were dissolved in 50 mL of deionized water in a polypropylene bottle. Fumed silica (Cab O Sil M 5, Cabot Corporation) was then added to the solution.

The final molar composition of the mixture was 100 SiO2: x Al³⁺: y Na⁺: 49.3 HMI: 4400 H₂O, with a Si Al ratio of approximately 15 (x: y=6.4:23.9).

The mixture prepared for MCM 22 synthesis was stirred at 200 rpm at room temperature until forming a homogeneous gel.

The gel was then transferred to a Teflon lined autoclave and sealed within a stainless steel vessel. Hydrothermal synthesis was carried out at 135° C. for 11 days while rotating at 60 rpm. After completion, the autoclave was quenched and cooled with tap water. The solid product was washed and centrifuged multiple times, then dried at 70° C. prior to calcination.

The dried MCM 22 product was calcined at 550° C. for 12 hours under an airflow of 500 mL per min at a heating rate of 1° C. per min to obtain calcined MCM 22.

To obtain the proton type zeolite support (H MCM 22), ion exchange was carried out. One gram of calcined MCM 22 was added to 100 g of a 1 M NH₄NO₃ aqueous solution (98 percent, Sigma Aldrich) and stirred at room temperature for at least 12 hours. The ion exchange procedure was repeated three times to ensure sufficient replacement of Nations. After ion exchange, the product was dried overnight at 70° C., and calcined again at 550° C. for 12 hours under an airflow of 300 mL per min at a heating rate of 1° C. per min to obtain the H MCM 22 zeolite support.

### 2. Hydrothermal Treatment of Zeolite Support

Hydrothermal treatment of the H MCM 22 support with a Si Al ratio of approximately 15 was conducted under an airflow of approximately 400 mL per min containing 10 mol percent steam. The treatment was carried out in a furnace at specified temperatures of 400, 500, or 600° C.

Approximately 1.0 g of H MCM 22 was placed in a quartz boat. After reaching the target temperature, deionized water was injected at a constant rate of 2 mL per hour. Lines connected to the quartz tube were wrapped with heating tape to maintain a 10 mol percent steam concentration.

Thus, a hydrothermally dealuminated H MCM 22 zeolite support was obtained.

### 3. Preparation of Mo Based Methane Dehydroaromatization Catalyst

An aqueous solution of ammonium heptamolybdate tetrahydrate (NH₄)₆Mo₇O₂₄·4H₂O (99 percent, Sigma Aldrich) was impregnated onto the hydrothermally treated H MCM 22 support. The Mo loading amount was fixed at 6 weight percent.

After impregnation, the sample was dried overnight at 70° C., then calcined at 550° C. for 12 hours under an airflow of 300 mL per min at a heating rate of 1° C. per min.

### 4. Catalyst Characterization

For catalyst characterization, the untreated H MCM 22 support was denoted as “M”, and the hydrothermally dealuminated supports were denoted as “M_x” (x=400, 500, 600). Mo loaded samples were designated as “Mo/M” and “Mo/M_x” (x=400, 500, 600).

### (1) Changes in Acid Sites According to Hydrothermal Treatment Temperature

To examine the changes in acid sites, Py adsorption FT IR and NH3 TPD measurements were conducted for Mo/M and Mo/M_x (x=400, 500, 600).

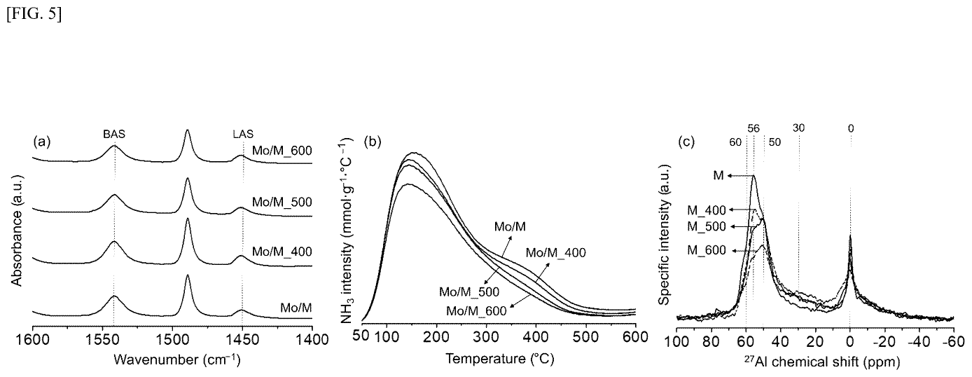

The state of aluminum in the framework was further analyzed by 27Al MAS NMR for M and M_x (x=400, 500, 600). The corresponding analyses are shown in FIG. 5.

FIG. 5 shows the following data: (a) Py adsorption FT IR spectra, (b) NH3 TPD profiles, and (c) 27Al MAS NMR spectra of M and M_x (x=400, 500, 600)

In FIG. 5(a), “BAS” refers to Brønsted acid sites and “LAS” refers to Lewis acid sites. Quantitative values of acid sites obtained from Py IR and NH3 TPD were summarized in Table 1.

From FIGS. 5 (a) and (b), it was confirmed that both Brønsted and Lewis acid sites decreased as the hydrothermal treatment temperature increased.

NH3 TPD analysis also indicated a reduction in Brønsted acidity with increasing hydrothermal treatment temperature.

For example, the Brønsted acidity of Mo/M_400 (501.3 μmol per g) was slightly lower than that of Mo/M (530.2 μmol per g), but still maintained a relatively high acid concentration. This indicates that hydrothermal treatment at 400° C. results in more favorable acid site preservation compared to treatments at 500° C. or 600° C.

In the Py-IR results, Mo/M_400 showed a slight increase in Brønsted acid intensity compared to Mo/M_500 and Mo/M_600. This suggests that although BAS decreases due to dealumination at 400° C., Mo loading on the partially dealuminated support generates additional Brønsted acid sites.

FIG. 5(c) shows 27Al MAS NMR spectra, where the peak at approximately 56 ppm corresponds to tetrahedral Al in the zeolite framework. A decrease in this peak intensity with increasing hydrothermal temperature confirms progressive removal of framework aluminum. This trend matches the reduction of Brønsted acid sites observed in the Py IR and NH3 TPD analyses.

Accordingly, hydrothermal treatment at 400° C. showed superior dealumination characteristics compared to treatments at 500° C. and 600° C.

TABLE 1

| | NH₃-TPD analysis | | Py-adsorbed FT-IR analysis | |
|---|---|---|---|---|
| | Brønsted | Lewis | Brønsted | Lewis |
| | acid sites | acid sites | acid sites | acid sites |
| Sample | (μmol · g⁻¹) | (μmol · g⁻¹) | (μmol · g⁻¹) | (μmol · g⁻¹) |
| Mo/M | 530.2 | 45.1 | 412.9 | 92.3 |
| Mo/M_400 | 501.3 | 41.2 | 436.5 | 118.9 |
| Mo/M_500 | 413.2 | 26.7 | 347.4 | 84.9 |
| Mo/M_600 | 334.2 | 19.4 | 250.8 | 69.7 |

### (2) MDA Reaction Characteristics Depending on Hydrothermal Treatment Temperature

Methane dehydroaromatization (MDA) reactions were performed using 0.2 g of the Mo based catalyst prepared above. Before reaction, each catalyst was pretreated at 550° C. under He flow for 1 hour. Thereafter, the temperature was increased to 700° C. at 2° C. per min, and the feed was switched to the reaction gas.

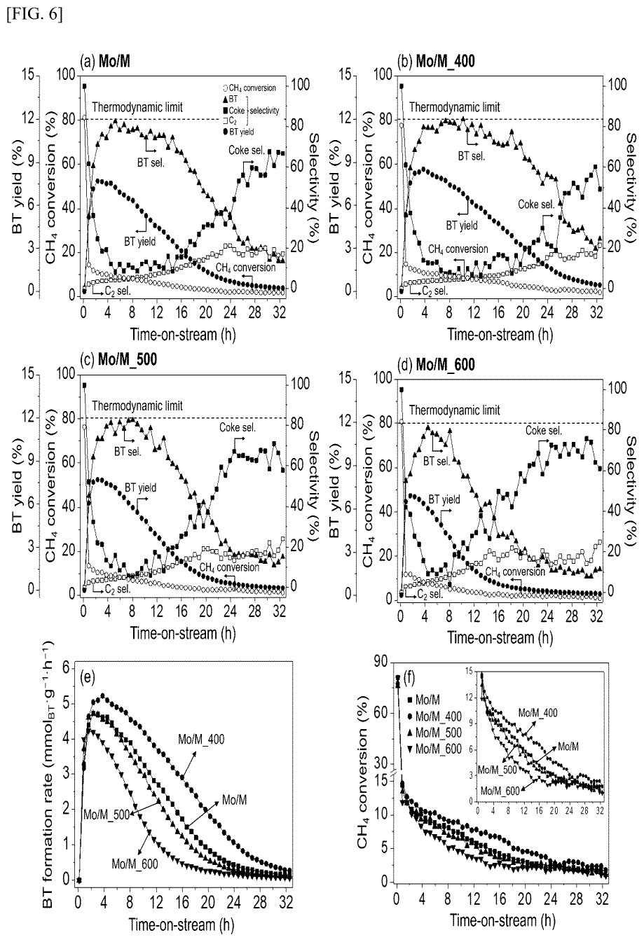

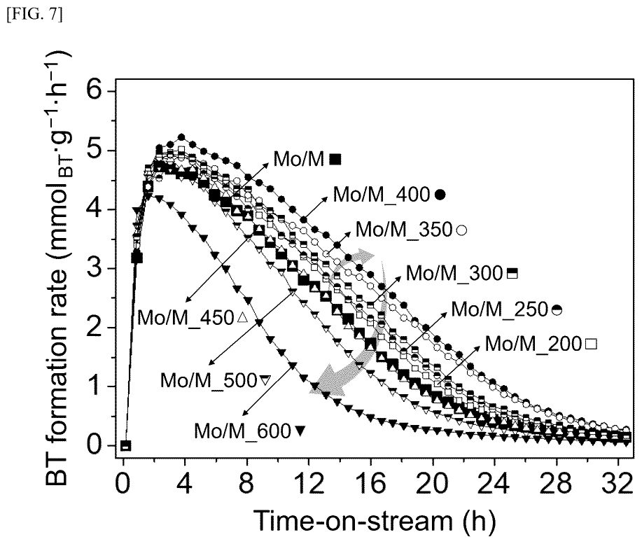

Catalyst activity was measured 10 minutes after feeding methane to ensure complete coverage over the catalyst bed. The MDA reaction results for Mo/M and Mo/M_x (x=400, 500, 600) are shown in FIG. 6.

FIG. 6 includes: (a) Mo/M and Mo/M_x (x=400, 500, 600) (b) Mo/M_400, (c) Mo/M_500, (d) Mo/M_600), (e) BT production rates of all catalysts, and (f) Methane conversion data.

All reactions were conducted at 700° C. and atmospheric pressure for 32 hours on stream (TOS), using CH₄/Ar (v/v=9/1) at a space velocity of approximately 1500 mL per g per h based on CH₄.

In FIGS. 6 (a) to 6 (d), the MDA catalytic performance during 32 hours of time-on-stream (TOS) is shown for four samples, namely Mo-based methane dehydroaromatization catalysts (Mo/M and Mo/M_x, where x=400, 500, and 600). For clarity, FIGS. 6 (e) and 6(f) respectively present separate plots of the benzene+toluene (BT) formation rate and the CH₄ conversion as a function of TOS.

All four catalysts exhibited similar time-dependent BT formation trends, which can be divided into three major stages: activation, induction, and deactivation. The activation stage corresponds to the initial period during which little or no BT products are detected (approximately TOS=0.2 h), because the Mo oxides must be carburized into active Mo carbide species by the CH₄ feed. After sufficient activation, BT products were first observed at approximately TOS=0.9 h, which may represent the induction period. Thereafter, all four catalysts reached their respective maximum BT formation rates, although at different TOS values: approximately 2.3, 3.8, 2.2, and 1.6 hours for Mo/M, Mo/M_400, Mo/M_500, and Mo/M_600, respectively. Finally, the BT formation rates declined due to unavoidable catalyst deactivation.

The Mo/M 400 catalyst exhibited the best MDA performance, and as shown in FIG. 6 (e), it achieved a higher BT formation rate than Mo/M over the entire TOS until complete catalyst deactivation. With respect to the hydrothermal treatment (HT) time, the 24-hour treatment provided the most favorable catalytic performance for Mo/M_400 compared to the other HT durations of 12, 36, and 48 hours. In contrast, at higher HT temperatures of 500° C. and 600° C., the BT formation rate no longer improved and instead catalyst deactivation was accelerated.

Furthermore, the increasing order of BT formation rates was Mo/M 400>Mo/M>Mo/M 500>Mo/M 600. This order was found to closely match the order of naphthalene formation rates over the entire TOS, and it also corresponded closely to the trend in CH₄ conversion between approximately 4 and 20 hours of TOS, as shown in FIG. 6 (f). With respect to CH₄ conversion, these results indicate that the spatial interaction between Mo species and Brønsted acid sites (BAS) within the zeolite support differs among the catalysts.

In addition, after 32 hours of MDA reaction, the BT yields followed the order Mo/M 400>Mo/M>Mo/M 500>Mo/M_600. Mo/M_400 exhibited the highest catalytic activity, achieving a BT yield of 8.5%, which was even higher than that of Mo/M (approximately 7.7%). The hydrothermal treatment at 400° C. induced appropriate dealumination and a corresponding reduction in Brønsted acid sites, resulting in higher activity than Mo/M. However, when the HT temperature exceeded 400° C., the catalytic activity decreased, and in particular, Mo/M_600, which underwent overly harsh hydrothermal treatment, exhibited poor performance with a maximum BT yield of only 6.9%.

FIG. 7 is a diagram illustrating measurement data including the MDA reaction of catalysts hydrothermally treated at temperatures of 200 to 600° C., according to an embodiment of the present invention for a Mo-based methane dehydroaromatization catalyst. In FIG. 7, screening was conducted for each of the catalysts (Mo/M_x; x=200, 250, 300, 350, 400, 450, 500, and 600), and the corresponding results are shown.

The Mo/M_400 catalyst exhibited the highest performance. At hydrothermal treatment temperatures below 400° C., the catalytic performance tended to improve relative to the reference catalyst Mo/M. Within the given reaction time range, hydrothermal treatment at temperatures above 400° C. did not further enhance the catalytic performance of the respective catalysts. When the catalyst characteristics were compared using Mo/M as a reference, Mo/M_400 showed the maximum performance, Mo/M_500 exhibited nearly comparable performance, and Mo/M_600 demonstrated inferior performance.

Accordingly, the catalyst sample hydrothermally treated at 400° C. displayed the most favorable MDA reaction data.

### (3) Coke Analysis After MDA Reaction Depending on Hydrothermal Treatment Temperature

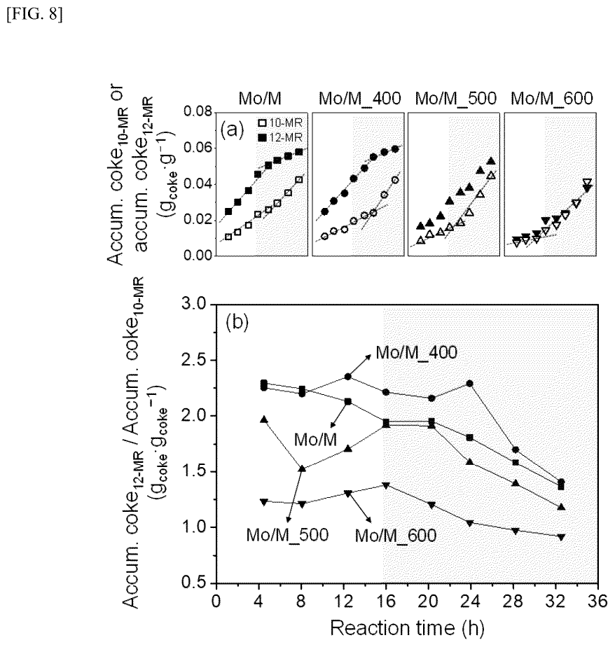

FIG. 8 is a diagram illustrating data obtained from coke analysis of the Mo-based methane dehydroaromatization (MDA) catalyst according to an embodiment of the present invention.

FIG. 8 (a) shows TGA measurement data indicating the amount of coke accumulated within the 10-MR or 12-MR pores as a function of reaction time for Mo/M and Mo/M_x (x=400, 500, 600).

FIG. 8 (b) depicts the ratio of coke accumulated in the 12-MR pores to that accumulated in the 10-MR pores for Mo/M and Mo/M_x (x=400, 500, 600) as a function of reaction time.

Coke analysis of Mo/M and Mo/M_x (x=400, 500, 600) after the MDA reaction was performed using TGA together with Ar adsorption-desorption measurements. In the case of the Mo/M_400 catalyst, which underwent hydrothermal treatment resulting in dealumination, it was confirmed that the amount of coke formed in the 10-MR pores was relatively lower than that of the Mo/M catalyst due to the suitably adjusted Brønsted acid sites (BAS), which can promote BT formation. This reduction in coke within the aromatics-selective 10-MR pores, combined with the enhanced capacity of the 12-MR pores to accommodate coke deposits during prolonged reaction times, contributes to improved stability of the Mo/M_400 catalyst.

Accordingly, the present invention enables modification of an MWW-type zeolite support (protonic MCM-22) through hydrothermal treatment, thereby achieving dealumination. Such dealumination allows the Brønsted acid sites to be controlled and reduces the formation of hard coke, which in turn increases the selectivity toward BTX (benzene, toluene, and xylenes) in methane dehydroaromatization (MDA) reactions. Ultimately, the invention enhances the performance of MDA catalysts and increases the production yield of aromatic compounds.

The present invention thus provides a hydrothermally treated and dealuminated MWW-type (protonic MCM-22) zeolite support, and catalysts may be prepared using this modified MWW-type zeolite. Catalysts prepared using such a modified MWW-type (protonic MCM-22) zeolite support can be effectively utilized not only in the above-described MDA reaction but also in a wide variety of catalytic applications requiring zeolite-based catalysts.

Although the embodiments of the present invention have been described above with reference to the accompanying drawings, it will be understood by those of ordinary skill in the art that the invention may be practiced in various other specific forms without departing from the technical spirit or essential characteristics thereof. Therefore, the embodiments described above are to be considered illustrative in all respects and not restrictive.

What is claimed is:

1. A hydrothermal treatment method for an MWW-type zeolite support, comprising

2. The method of claim 1,
/Al ratio of 5 to 60.

3. The method of claim 1, wherein obtaining the dealuminated zeolite support comprises hydrothermally treating the support under an air stream containing 1 to 80 mol % steam at a flow rate of 50 to 5000 mL·min⁻¹.

4. The method of claim 1, wherein obtaining the dealuminated zeolite support comprises hydrothermally treating the support while injecting deionized water at a constant rate of 1 to 100 mL·h⁻¹.

5. The method of claim 1, wherein synthesizing the protonic zeolite support comprises:
preparing an MCM-22 zeolite precursor;

6. The method of claim 5, wherein preparing the MCM-22 zeolite precursor comprises:
hexamethyleneimine (HMI), sodium aluminate, and sodium hydroxide in deionized water; and
wt % Al₂O₃ and 45 wt % Na₂O.

7. The method of claim 5, wherein obtaining the calcined MCM-22 zeolite comprises heat-treating the solid product at 400 to 650° C. for 3 to 48 hours at a heating rate of 1 to 5° C.· min⁻¹ under an air flow rate of 50 to 5000 mL·min⁻¹.

8. The method of claim 5, wherein ion-exchanging the calcined MCM-22 zeolite comprises stirring the calcined MCM-22 zeolite in an aqueous NH₄NO₃ solution at room temperature for 12 to 24 hours to exchange Na⁺ ions contained in the calcined MCM-22 zeolite.

9. The method of claim 5, wherein obtaining the protonic MCM-22 zeolite support comprises calcining the ion-exchanged MCM-22 zeolite at 400 to 650° C. for 12 to 24 hours at a heating rate of 1 to 5° C.·min⁻¹ under an air flow rate of 50 to 5000 mL·min⁻¹.

10. A method for preparing a Mo-based methane dehydroaromatization catalyst using a dealuminated MWW-type zeolite support obtained by hydrothermal treatment, the method comprising:
dehydroaromatization catalyst.

11. The method of claim 10, wherein impregnating Mo onto the hydrothermally treated protonic MCM-22 zeolite support comprises impregnating the support with an aqueous ammonium heptamolybdate tetrahydrate (NH₄)₆Mo₇O₂₄·4H₂O solution.

12. The method of claim 10, wherein impregnating Mo onto the hydrothermally treated protonic MCM-22 zeolite support comprises depositing Mo at a loading amount of 1 to 10 wt %.

13. The method of claim 10, wherein calcining to synthesize the Mo-based methane dehydroaromatization catalyst comprises calcining the Mo-impregnated support at 500 to 600° C. at a heating rate of 1 to 5° C.·min⁻¹ under an air flow rate of 50 to 5000 mL·min⁻¹.

14. The method of claim 10, wherein the hydrothermally treated protonic MCM-22 zeolite support is a protonic MCM-22 zeolite support prepared by the hydrothermal treatmentmethod according to claim 1.
